(19) United States
(12) Patent Application Publication
(10) Pub. No.: US 2024/0275587 A1
(43) Pub. Date: Aug. 15, 2024

(54) METHODS AND APPARATUS TO GENERATE LOCATION-BASED CRYPTOGRAPHIC KEYS

(71) Applicant: Intel Corporation, Santa Clara, CA (US)

(72) Inventors: Yaron Klein, Rosh HaAyin (IL); Dan Horovitz, Rishon Letzion (IL); Yoni Kahana, Ein Sarid (IL); Ilil Blum Shem-Tov, Kiryat Tivon (IL)

(21) Appl. No.: 18/620,197

(22) Filed: Mar. 28, 2024

(51) Int. Cl. H04L 9/08

(52) U.S. Cl. CPC H04L 9/0872

(57) ABSTRACT

Systems, apparatus, articles of manufacture, and methods are disclosed to generate location-based cryptographic keys. An example includes a non-transitory computer readable medium comprising instructions that, when executed, cause a machine to at least determine an encryption key, and combine the encryption key with a parameter based on a physical characteristic of a wireless network environment to generate a cryptographic key.

### FIELD OF THE DISCLOSURE

This disclosure relates generally to data security and, more particularly, to methods and apparatus to generate location-based cryptographic keys.

### BACKGROUND

In recent years, digital data has grown more widespread and mobile. Remote access to data is becoming the norm, and data security has become increasingly more important. One method of data security is data encryption, where the data is transformed to an encrypted (e.g., obfuscated, unusable, unparseable, etc.) form through the use of an encryption key. The encrypted data can later be decrypted by transforming the encrypted data using the same encryption key that was used to initially encrypt the data. Thus, only users with the encryption key (or a different corresponding key) can access the encrypted data. Encryption keys can be derived from a variety of sources such as passwords, random number generators, biometrics, or other security algorithms.

### BRIEF DESCRIPTION OF THE DRAWINGS

FIG. 1 is a block diagram of an example computing device that operates to encrypt and decrypt data.

FIG. 2 is a flowchart representative of example machine readable instructions and/or example operations that may be executed, instantiated, and/or performed by example programmable circuitry to implement the computing device of FIG. 1 to encrypt data.

FIG. 3 is a flowchart representative of example machine readable instructions and/or example operations that may be executed, instantiated, and/or performed by example programmable circuitry to implement the computing device of FIG. 1 to decrypt data.

FIG. 4 illustrates an example computing device as it registers an example key and encrypts an example secret document.

FIG. 5A illustrates the example computing device of FIG. 4 attempting to decrypt a secret document from outside of an allowed geographic area.

FIG. 5B illustrates the example computing device of FIG. 4 attempting to decrypt the secret document from within the allowed geographic area.

FIG. 6 is a block diagram of an example processing platform including programmable circuitry structured to execute, instantiate, and/or perform the example machine readable instructions and/or perform the example operations of FIGS. 2 and/or 3 to implement the computing device of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 2 and/or 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In the era of increasing digitalization and mobility, ensuring secure access to data and systems is a significant challenge. Known methods of access control based on passwords or biometrics may not be sufficient in certain scenarios where location-based access control is required. For instance, certain sensitive information or systems should only be accessible within a specific location (e.g., geographical location, office building, room, etc.). Furthermore, these conventional methods are also susceptible to various security threats like password theft or biometric spoofing.

Known methods for protecting data rely heavily on external factors and lack the ability to provide a robust layered security approach, leaving systems vulnerable if a single factor is compromised. Furthermore, known methods do not incorporate the concept of key separation, leaving a potential vulnerability if the keys are stored in a single location like the cloud.

Example methods and apparatus disclosed herein generate location-based cryptographic keys based on a physical characteristic of a wireless network environment. The physical space around a wireless network affects measurable aspects of the wireless network, such as signal return or clock synchronization time with an access point, in a way that can be used to generate cryptographic keys. Example methods and apparatus disclosed herein combine the physical characteristic of the wireless network environment with a key (e.g., a traditional encryption key such as a self-generated key). This approach creates a new cryptographic key that not only ensures secure access but also binds it to a specific geographical location (e.g., physical location relative to the wireless network). Access to a certain system or data will be granted if the generated key and the location of an accessing device are correctly matched, thus adding an extra layer of security. In some examples, the user is able to define the area and policy under which the key will operate (e.g., through a SaaS platform such as a cloud or local platform), thus customizing the access control to their specific needs. In addition, the physical parameters used to generate the cryptographic key can be saved in the cloud or any other preferred location. Storing the key allows for recovery of the cryptographic key in case of loss, ensuring continued secure access without disruption. This hybrid approach of utilizing both physical and digital security measures provides a robust and reliable access control system. Beyond access control alone, the methods and apparatus disclosed herein ensure that without both the key and the location parameters (which are unique and require proximity), the encrypted assets are not available at all.

In corporate settings, methods and apparatus disclosed herein can be used to restrict access to sensitive documents and data to a specific geographical location. For example, a multinational corporation may use methods and apparatus disclosed herein to ensure that certain confidential documents can only be accessed within the premises of the corporation's headquarters. This would prevent unauthorized access to these documents from other locations, such as remote offices, public places, or employees' homes. This would significantly enhance the security of the corporation's data and reduce the risk of data leakage. Unlike known solutions, spoofing the location and a software breach would not comprise the documents.

In healthcare settings, hospitals can use methods and apparatus disclosed herein to ensure that patient records and other sensitive medical data can only be accessed within the hospital premises. This would prevent unauthorized access to these records from outside the hospital, such as from the homes of healthcare professionals or from other healthcare facilities. This would not only enhance the security of patient data but would also help hospitals comply with regulations regarding the privacy and security of medical data.

For individuals who own cryptocurrency, methods and apparatus disclosed herein can be used to restrict access to their cryptocurrency wallets to a specific geographical location, such as their homes. This would prevent attackers from accessing and using their wallets from other locations. This would provide an additional layer of security for their cryptocurrency assets, reducing the risk of theft or unauthorized transactions.

In these use cases, methods and apparatus disclosed herein would provide a significant improvement in security by tying access control to a specific geographical location, and by using a secure key stored in a hardware that is resistant to common hacking methods. The cloud-based SaaS control system would provide flexibility by allowing the allowed perimeter to be updated in real-time.

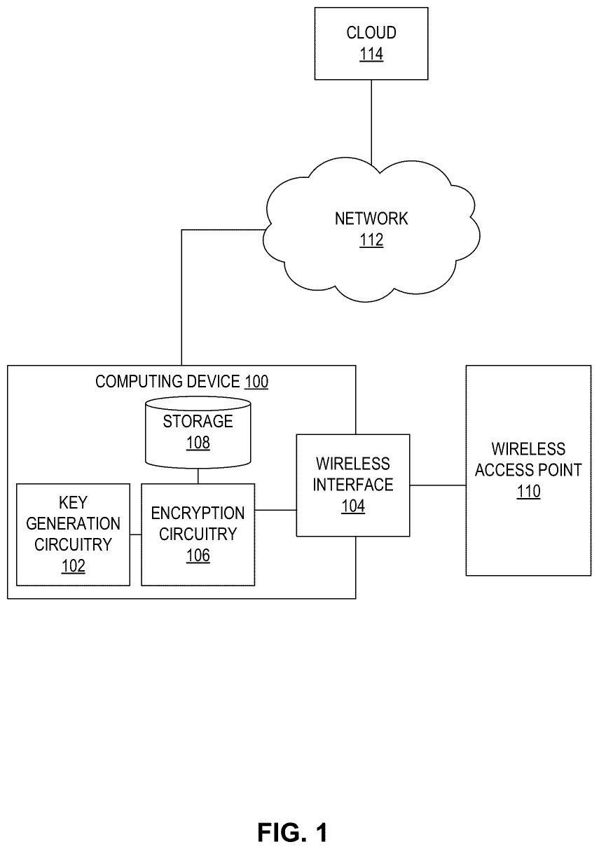

FIG. 1 is a block diagram of an example computing device 100 that operates to encrypt and decrypt data. The computing device 100 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the computing device of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example computing device 100 of FIG. 1 includes example key generation circuitry 102, an example wireless interface 104, example encryption circuitry 106, and example storage 108. The computing device 100 is in communication with an example wireless access point 110, an example network 112, and an example cloud 114.

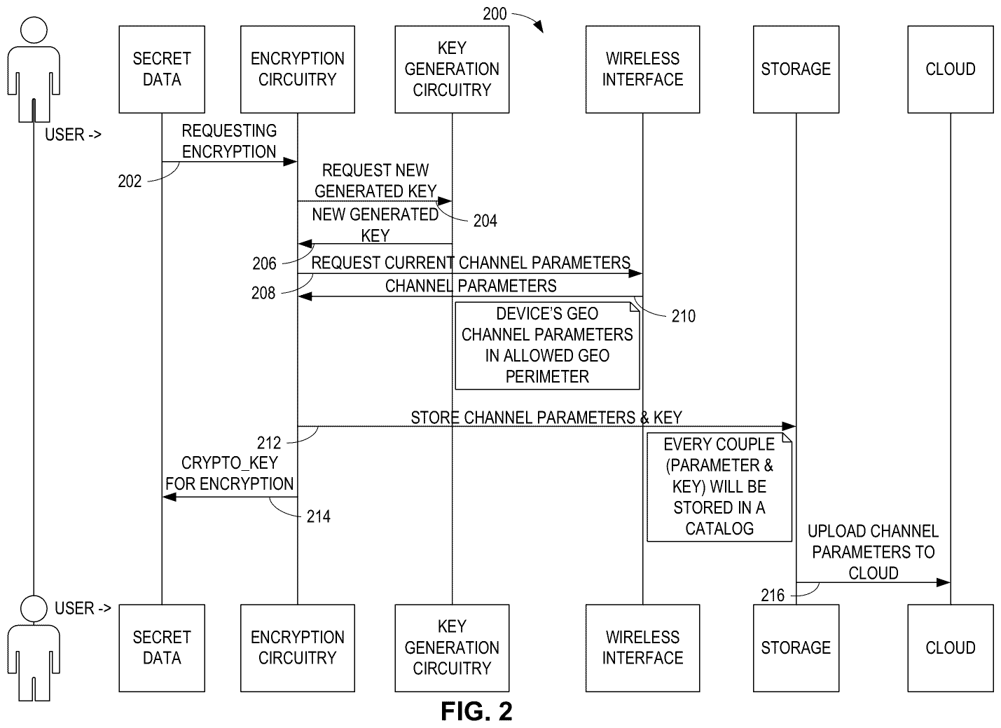

The key generation circuitry 102 of FIG. 1 generates an encryption key for use by the encryption circuitry 106. In some examples, the key generation circuitry 102 uses a random number generator to generate the encryption key. In other examples, the key generation circuitry 102 uses known key generating algorithms to generate a suitable encryption key. In some examples, the encryption key is stored in the storage 108 for later retrieval. In some examples, the key generation circuitry 102 is instantiated by programmable circuitry executing key generation instructions and/or configured to perform operations such as those represented by the flowchart(s) of FIG. 2.

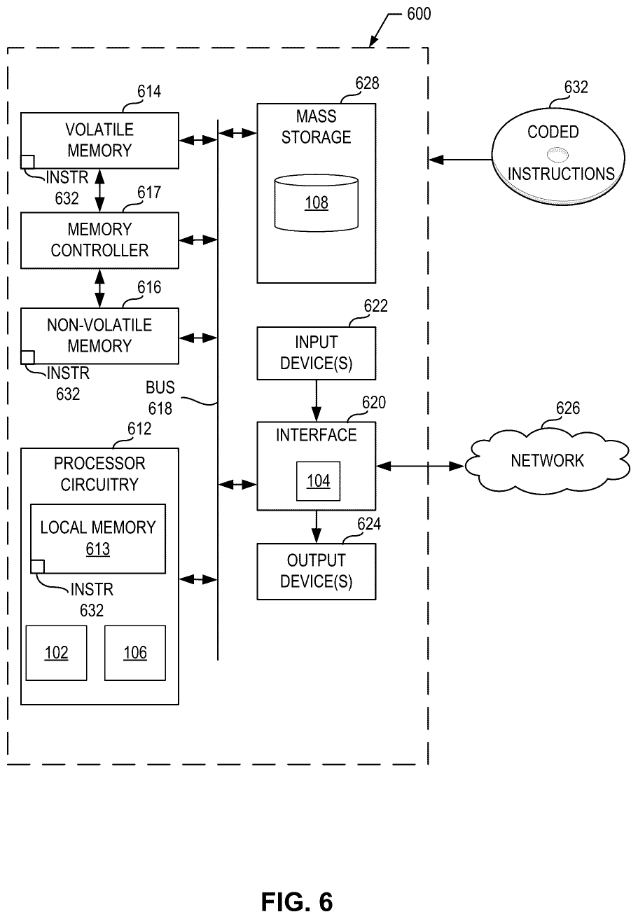

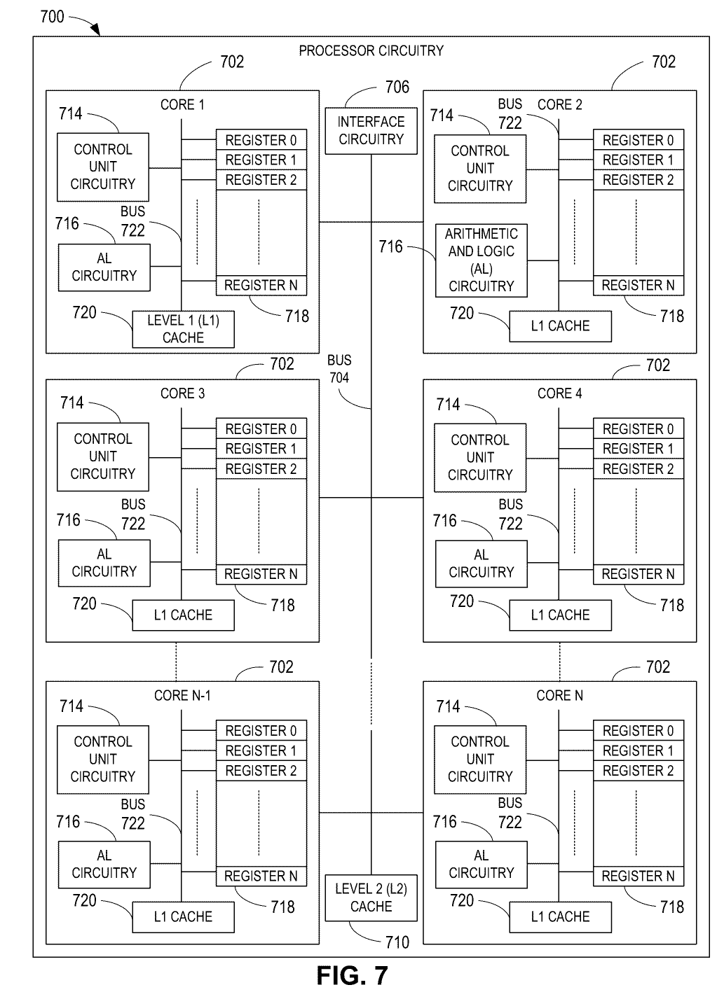

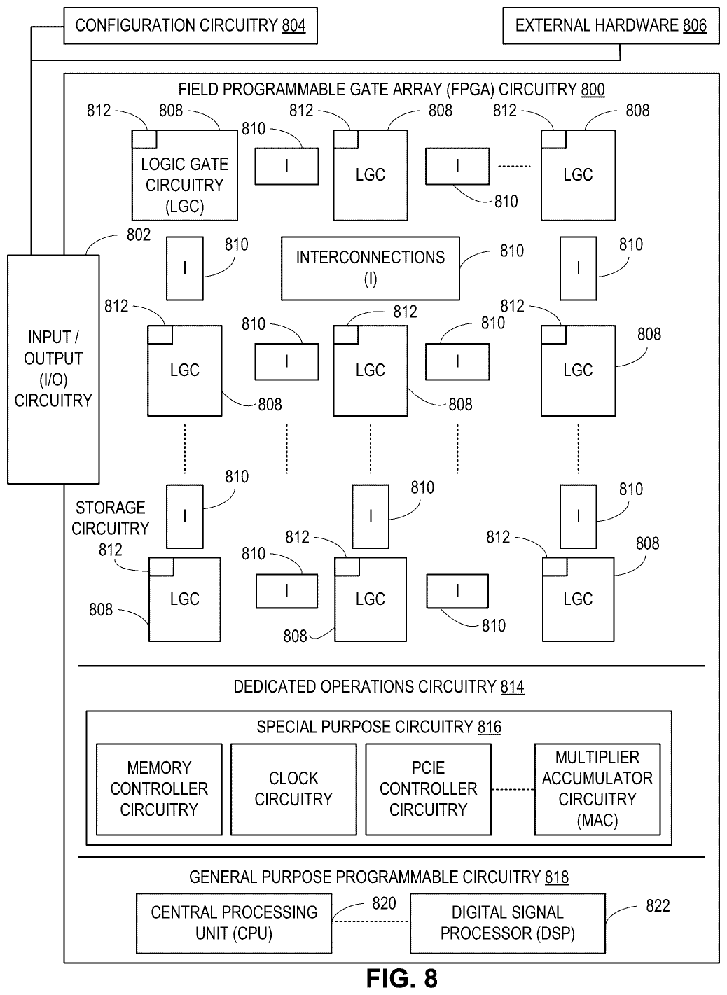

In some examples, the computing device 100 includes means for generating an encryption key. For example, the means for generating may be implemented by key generation circuitry 102. In some examples, the key generation circuitry 102 may be instantiated by programmable circuitry such as the example programmable circuitry 612 of FIG. 6. For instance, the key generation circuitry 102 may be instantiated by the example microprocessor 700 of FIG. 7 executing machine executable instructions such as those implemented by at least blocks 204, 206 of FIG. 2. In some examples, the key generation circuitry 102 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the key generation circuitry 102 may be instantiated by any other combination of hardware, software, and/or firmware. For example, the key generation circuitry 102 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The wireless interface 104 of the computing device 100 of FIG. 1 communicates with the wireless access point 110. In some examples, the computing device 100 connects to the network 112 through the wireless interface 104 communicating with wireless access point 110. In other examples the computing device connects to the network 112 through other means, such as the interface 620 (discussed in further detail below in relation to FIG. 6). The wireless interface 104 communicates with the wireless access point 110 to determine a physical characteristic (e.g., a channel parameter, parameter, etc.) of a wireless network environment generated by the wireless access point 110. In some examples, a plurality of physical characteristics (e.g., channel parameters, parameters, etc.) are determined. The physical characteristics of the wireless network environment reflect the location (e.g., geographic location, position relative to the wireless access point 110, etc.) in which the computing device 100 is operating. Thus, the physical characteristics of the wireless network environment vary in response to the location of the computing device 100. In this way, the physical characteristics of the wireless network environment represent a combined signature of the computing device 100, the wireless interface 104, the wireless access point 110, the location of the computing device 100, and the physical environment containing the computing device 100 and the wireless access point 110. In some examples, the physical characteristics of the wireless network environment are stored in the storage 108 and/or the cloud 114. In some examples, the wireless interface 104 is instantiated by programmable circuitry executing wireless interface instructions and/or configured to perform operations such as those represented by the flowchart(s) of FIGS. 2 and/or 3.

An example physical characteristic of a wireless network environment is the signal return. In a Multiple-Input, Multiple Output (MIMO) Wi-Fi system, the signal return is significantly influenced by the physical environment. Factors such as the number and type of obstacles (like walls, furniture, etc.) can all affect the signal return. The signal return in a MIMO Wi-Fi system is complex due to the multiple signal paths and the impact of multipath propagation. Therefore, each measurement of signal return can be unique to the specific location and setup. The signal return can be reproduced if the physical conditions remain the same.

An example method to calculate the signal return in a MIMO Wi-Fi system is to use the Signal-to-Noise Ratio (SNR) formula:

$$SNR = {P}_{signal} / {P}_{n o i s e}$$

Where P_{signal} is the power of the received signal (e.g., signal power), and Pₙₒᵢₛₑ is the power of the noise (e.g., noise power). Hence, the SNR is known (e.g., via measurements) and the power of the noise in the system, the power of the received signal can be calculated, which is essentially the signal return. In a MIMO Wi-Fi system, the SNR may be calculated for each antenna and then these SNR values can be combined to calculate the overall SNR of the MIMO Wi-Fi system. Signal power, noise power, signal to noise ratio, and signal return are all examples of physical characteristics that can be used with the methods and apparatus described herein.

Another example physical characteristic of a wireless network environment is clock synchronization time. Clock synchronization time is the time it takes for a device to synchronize its clock with a wireless access point (e.g., the time to perform a synchronization process), which is also influenced by the physical environment and network conditions. Network latency, which can be affected by the distance between the device and wireless access point, network congestion, and the quality of the network connection play a major role in clock synchronization time. Like signal return, clock synchronization time can also be reproduced under the same physical conditions. Synchronization time calculation can be represented in the following formula and procedure:

$$ClockSyncedTime = {t}_{2} + ( ( {t}_{3} - {t}_{1} ) / 2 )$$

1. Measure the time at the local device (t₁)
2. Request the time from the wireless access point (t₂)
3. Measure the time at the local device again (t₃) after receiving the time from the wireless access point
4. Calculate the latency as:

$$( {t}_{3} - {t}_{1} ) / 2 = latency$$

5. Set clock synced time with the wireless access point:

$${t}_{2} + latency = ClockSyncedTime$$

This is a basic synchronization method which assumes the network latency is symmetrical (i.e., the time taken to send a packet from the device to AP is the same as the time taken from AP to the device). In some examples, transmission time latency between the computing device and the wireless access point is used as a physical characteristic of the wireless network environment (e.g., channel parameter).

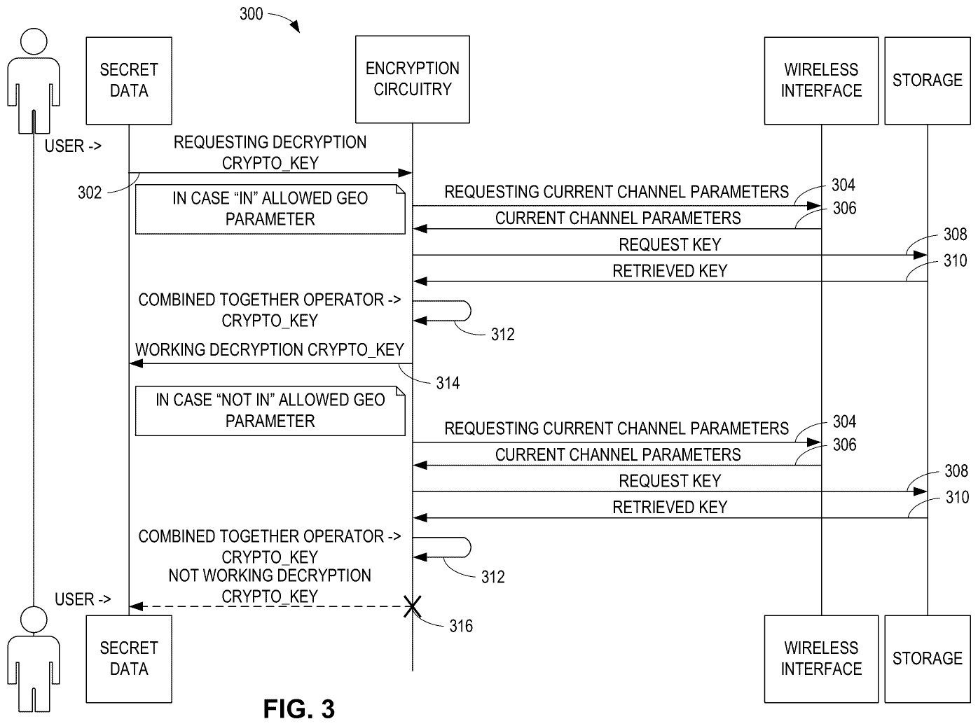

In some examples, the computing device 100 includes means for determining a physical characteristic of a wireless network environment. For example, the means for determining may be implemented by a wireless interface 104. In some examples, the wireless interface 104 may be instantiated by circuitry (e.g., programmable circuitry, embedded circuitry, etc.) such as the interface circuitry 620 of FIG. 6. In some examples, the wireless interface 104 may be instantiated by programmable circuitry such as the example programmable circuitry 612 of FIG. 6. For instance, the wireless interface 104 may be instantiated by the example microprocessor 700 of FIG. 7 executing machine executable instructions such as those implemented by at least blocks 208, 210, 304, 306, 316, and 318 of FIGS. 2 and 3. In some examples, the wireless interface 104 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the wireless interface 104 may be instantiated by any other combination of hardware, software, and/or firmware. For example, the wireless interface 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The encryption circuitry 106 of FIG. 1 encrypts and decrypts data to allow secure access and storage of data (e.g., secure data, secret data, secret documents, etc.). The encryption circuitry 106 receives an encryption key from the key generation circuitry 102 and combines the encryption key with a physical characteristic of a wireless network environment determined by the wireless interface 104 in order to generate a cryptographic key. The cryptographic key is used to encrypt and decrypt data using suitable known encryption methods (e.g., AES). In some examples, the cryptographic key is not stored, but rather generated by the encryption circuitry 106 using the stored encryption key and a physical characteristic of the wireless network environment detected at the time decryption of the data is requested. In some examples, the cryptographic key is generated by performing an exclusive OR operation using the encryption key and the physical characteristic of the wireless network environment. In this way, the data can only be decrypted (e.g., accessed) when the computing device 100 is in the correct location (e.g., physical position within the wireless network). In some examples, the encryption circuitry 106 is instantiated by programmable circuitry executing encryption instructions and/or configured to perform operations such as those represented by the flowchart(s) of FIGS. 2 and/or 3.

In some examples, the computing device 100 includes means for generating a cryptographic key. For example, the means for generating may be implemented by encryption circuitry 106. In some examples, the encryption circuitry 106 may be instantiated by programmable circuitry such as the example programmable circuitry 612 of FIG. 6. For instance, the encryption circuitry 106 may be instantiated by the example microprocessor 700 of FIG. 7 executing machine executable instructions such as those implemented by at least blocks 202, 204, 206, 208, 210, 212, 214, 302, 304, 306, 308, 310, 312, 314, 316, 318, 320, 322, 324, and 326 of FIGS. 2 and 3. In some examples, the encryption circuitry 106 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the encryption circuitry 106 may be instantiated by any other combination of hardware, software, and/or firmware. For example, the condition determination circuitry _00 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the computing device 100 is illustrated in FIG. 1, one or more of the elements, processes, and/or devices illustrated in FIG. 1 may be combined, divided, re-arranged, omitted, eliminated, and/or implemented in any other way. Further, the example key generation circuitry 102, the example wireless interface 104, the example encryption circuitry 106, the example storage 108, and/or, more generally, the example computing device 100 of FIG. 1, may be implemented by hardware alone or by hardware in combination with software and/or firmware. Thus, for example, any of the example key generation circuitry 102, the example wireless interface 104, the example encryption circuitry 106, the example storage 108, and/or, more generally, the example computing device 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example computing device 100 of FIG. 1 may include one or more elements, processes, and/or devices in addition to, or instead of, those illustrated in FIG. 1, and/or may include more than one of any or all of the illustrated elements, processes and devices.

Flowcharts representative of example machine readable instructions, which may be executed by programmable circuitry to implement and/or instantiate the computing device 100 of FIG. 1 and/or representative of example operations which may be performed by programmable circuitry to implement and/or instantiate the computing device 100 of FIG. 1, are shown in FIGS. 2 and/or 3. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2 and/or 3, many other methods of implementing the example computing device 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2 and/or 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to implement the computing device 100 of FIG. 1 to encrypt data. The example machine-readable instructions and/or the example operations 200 of FIG. 2 begin at block 202, at which the encryption circuitry 106 receives a request to encrypt secret data. The secret data can be any data or documents of a sensitive nature that the user wants to restrict access to. The example operations continue to block 204, where the encryption circuitry 106 sends a request to the key generation circuitry 102 to generate a new encryption key. At block 206, the key generation circuitry 102 generates an encryption key and sends it to the encryption circuitry 106. Alternatively, the encryption key may be obtained in any other manner (e.g., retrieval of a locally stored key, retrieval of a key from a remote location/system, etc.). The operations continue to block 208, where the encryption circuitry 106 requests the current channel parameters (e.g., the current physical characteristics of a wireless network environment) from the wireless interface 104.

At block 210 of the example operations 200 of FIG. 2, the example wireless interface 104 determines the current channel parameters and returns them to the encryption circuitry 106. The channel parameters are physical characteristics of a wireless network environment. In other words, the wireless interface 104 extracts measurable aspects of the wireless signals (e.g., Wi-Fi signals) being sent from the wireless access point 110. As wireless signals interact with the physical environment (e.g., room size, room shape, furniture, etc.), properties of the wireless signal change creating unique physical characteristics of the wireless network that are difficult to replicate. Thus, the wireless interface 104 determines the physical characteristics of the wireless network as it is affected by its surroundings.

Once the current channel parameters (e.g., the current physical characteristics of the wireless network environment) have been determined by the wireless interface 104, the example operations 200 continue to block 210 where the channel parameters are sent to the encryption circuitry 106. The operation continues to block 212, where the encryption key and channel parameters are stored in a key catalog in the storage 108. The operation continues to block 214, where the encryption circuitry 106 creates a cryptographic key with the encryption key and at least one channel parameter (e.g., physical characteristic of the wireless network environment). In some examples, the channel parameters are run through an add crypto operation with the encryption key by the encryption circuitry 106, creating a new cryptographic key that is inherently linked to the specific physical location where the cryptographic key was generated. In some examples, the cryptographic key is generated by performing an exclusive OR operation using the encryption key and at least one channel parameter. In some examples, creating the cryptographic key is a one direction cryptography process that cannot be reversed. The cryptographic key is used to encrypt the secret data, thus protecting the secret data. The operation concludes at block 216 where channel parameters (e.g., physical characteristics of the wireless network environment at the time of cryptographic key generation) are stored on the cloud for later recovery if necessary. This not only ensures the recovery of the key in case of loss but also enables the key to be updated dynamically based on changes in the Wi-Fi environment or user-defined policy.

FIG. 3 is a flowchart representative of example machine readable instructions and/or example operations 300 that may be executed, instantiated, and/or performed by programmable circuitry to implement the computing device 100 of FIG. 1 to decrypt data. The example machine-readable instructions and/or the example operations 300 of FIG. 3 begin at block 302, at which the computing device 100 requests decryption of secret data (e.g., a secret document) from the encryption circuitry 106 based on a user input. The operation continues to block 304 where the encryption circuitry 106 requests the current channel parameters (e.g., physical characteristics of the wireless network environment) from the wireless interface 104. At block 306, the channel parameters are provided to the encryption circuitry 106 by the wireless interface 104. The operation continues at block 308 where the encryption circuitry 106 requests the encryption key corresponding to the secret data. At block 310, the encryption key is retrieved by the encryption circuitry 106. At block 312, the encryption circuitry 106 combines the encryption key and one or more of the channel parameters to generate (e.g., by performing a cryptographic operation) a cryptographic key. If the computing device 100 is located in an allowed access area, the cryptographic key will work and the operation can continue to block 314 where the secret data is decrypted. If the computing device is not located in the allowed access area, the cryptographic key will not work, and the operation continues to block 316 where the secret data is not successfully decrypted.

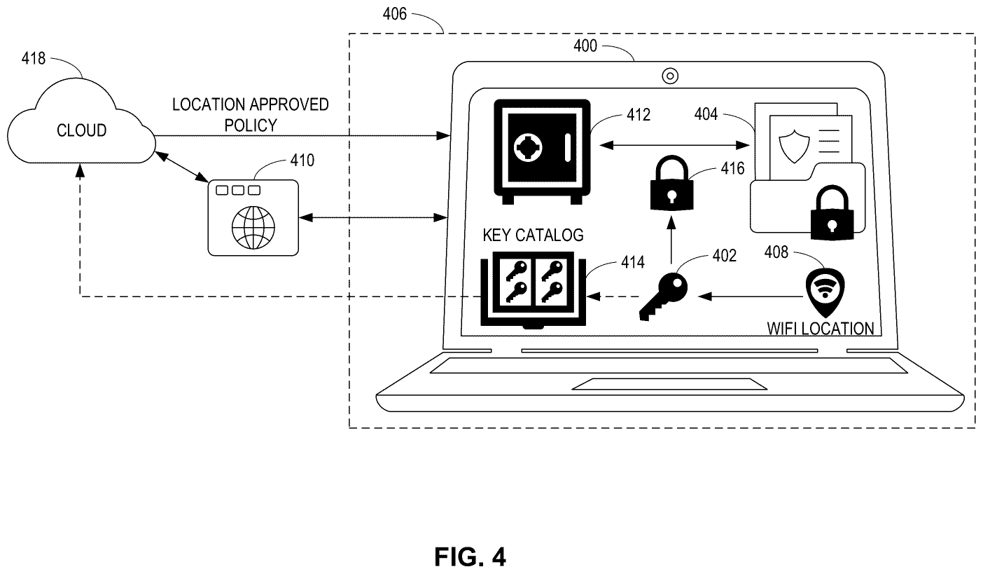

FIG. 4 illustrates an example computing device 400 as it registers an example encryption key 402 and encrypts and example secret document 404. The computing device 400 can be any computing device (e.g., machine, enclave, personal computer, laptop, mobile phone, portable device, etc.) configured similarly to the example computing device 100 of FIG. 1. The computing device 400 is located within an allowed geographic area 406 (e.g., secured location, target location, etc.). The allowed geographic area 406 is located within a physical wireless network environment, which includes the areas able to communicate with a location Wi-Fi 408 (e.g., a location wireless access point). In some examples, the physical wireless network environment is larger than the allowed geographic area 406. In some examples, the allowed geographic area 406 represents a safe and secure location where the secret document 404 can be accessed. In some examples, the location Wi-Fi 408 connects the computing device 400 to an example network 410. In other examples, the computing device 400 connects to the network 410 through other means, and the location Wi-Fi 408 is used solely to determine that the computing device 400 is within the allowed geographic area 406.

The example computing device 400 of FIG. 4 registers the encryption key 402 in response to a user request to encrypt the secret document 404 and securely store it in an example secure data storage 412. In some examples, the encryption key 402 is randomly generated and stored in an example key catalog 414 for later retrieval. The encryption key 402 and location parameters (e.g., the physical characteristics of the wireless network environment) provided by the location Wi-Fi 408 are sent to an example encryption module 416 (e.g., encryption circuitry). The encryption module 416 encrypts and decrypts the secret document 404 based on combining the encryption key 402 and at least one location parameter into an example location-based key (e.g., cryptographic key).

In some examples, the example computing device 400 of FIG. 4 is connected to an example cloud 418 through the network 410. In some examples, the cloud 418 is used to store the location parameters provided by the location Wi-Fi 408 (e.g., channel parameters, physical characteristics of the wireless network environment) for back up purposes. In other examples, the encryption key 402 is stored in the cloud 418. In some examples, a location policy can be implemented via a software as a service platform (SaaS) through the cloud 418. This allows for customizing the access control to specific needs. The user can define the area and policy for the operation of the encryption key 402 via the SaaS platform. This policy determines where and under what conditions the encryption key 402 will grant access. When an access request is made, the SaaS system verifies whether the geographic area 406 matches the policy and whether the encryption key 402 generated from the current Wi-Fi environment matches the stored key. If both conditions are met, access is granted; otherwise, the decryption operation won't be completed. This method ensures a high level of security that considers both the physical location and the unique Wi-Fi environment.

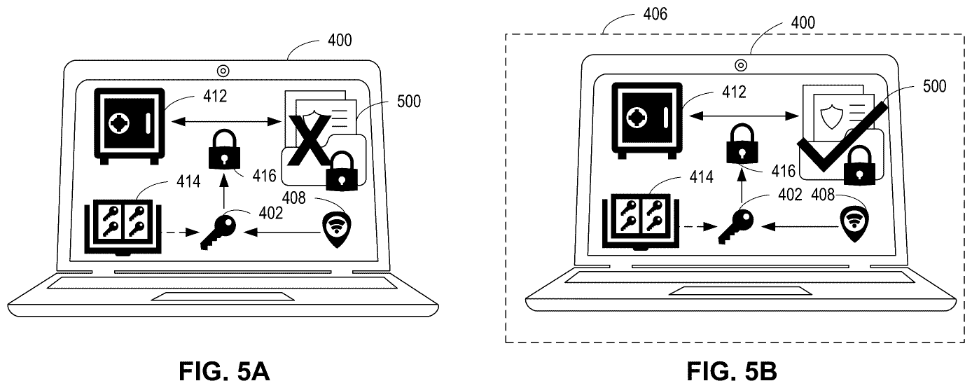

FIG. 5A illustrates the example computing device 400 of FIG. 4 attempting to decrypt a secret document 500 from outside of an allowed geographic area 406. The encryption key 402 is retrieved from the key catalog 414. The location Wi-Fi 408 provides location parameters (e.g., the physical characteristics of the wireless network environment). The encryption module 416 combines the location parameters and the encryption key 402 and attempts to decrypt the secret document 500. However, because the geographic location of the computing device 400 is incorrect (e.g., outside of the allowed geographic area 406), the encryption module 416 fails to decrypt the secret document 500.

FIG. 5B illustrates the example computing device 400 of FIG. 4 attempting to access the secret document 500 from within the allowed geographic area 406. The encryption key 402 is retrieved from the key catalog 414. The location Wi-Fi 408 provides location parameters (e.g., the physical characteristics of the wireless network environment). The encryption module 416 combines the location parameters and the encryption key 402 and attempts to decrypt the secret document 500. As the computing device 400 is in the allowed geographic area 406, the encryption module successfully decrypts the secret document 500.

FIG. 6 is a block diagram of an example programmable circuitry platform 600 structured to execute and/or instantiate the example machine-readable instructions and/or the example operations of FIGS. 2 and/or 3 to implement the computing device 100 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example key generation circuitry 102 and the example encryption circuitry 106.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. The example interface 620 includes the example wireless interface 104.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. The example mass storage 628 also includes the storage 108.

The machine readable instructions 632, which may be implemented by the machine readable instructions of FIGS. 2 and/or 3, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 2 and/or 3 to effectively instantiate the circuitry of FIG. 2 as logic circuits to perform operations corresponding to those machine readable instructions. In some such examples, the circuitry of FIG. 1 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 2 and/or 3.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 2 and/or 3 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2 and/or 3. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2 and/or 3. As such, the FPGA circuitry 800 may be configured and/or structured to effectively instantiate some or all of the operations/functions corresponding to the machine readable instructions of the flowchart(s) of FIGS. 2 and/or 3 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 2 and/or 3 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 2 and/or 3 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 2 and/or 3 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 2 and/or 3, and/or an ASIC may be configured and/or structured to perform third operation(s)/function(s) corresponding to a third portion of the machine readable instructions represented by the flowcharts of FIGS. 2 and/or 3.

It should be understood that some or all of the circuitry of FIG. 1 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 1 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

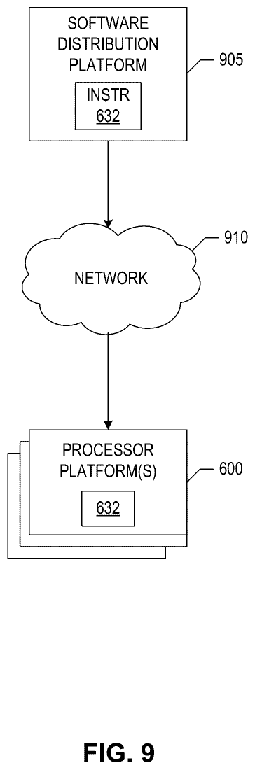

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 2 and/or 3, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 2 and/or 3, may be downloaded to the example programmable circuitry platform 600, which is to execute the machine readable instructions 632 to implement the computing device 100. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve access control and security of data by requiring actual physical presence to generate and use a cryptographic key. The methods and apparatus disclosed herein enable access control based on a geographical location of a user, preventing unauthorized access from outside a specified area. By combining the distinct physical characteristics of Wi-Fi signals with a self-generated key, the methods and apparatus disclosed herein provide a higher level of security compared to known methods that require physical proximity to decrypt data. The physical characteristics of the Wi-Fi signals (e.g., channel parameters) used to generate the cryptographic key can, in some example methods and apparatus disclosed herein, be saved in a cloud to allow for recovery of the cryptographic key in the event of loss to ensure continued secure access without disruption. The cryptographic key, constructed of two elements, is not entirely stored in the cloud, providing an extra layer of security. Even in the event of a cloud breach, assets aren't exposed, as the key still requires channel parameters to work locally. The methods and apparatus disclosed herein further enable users to customize access control to specific needs by defining an area and a policy under which the cryptographic key will operate via a SaaS platform. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to generate location-based cryptographic keys are disclosed herein. Further examples and combinations thereof include the following:

Example 1 includes a non-transitory computer readable medium comprising instructions that, when executed, cause a machine to at least determine a encryption key, and combine the first cryptographic key with a parameter based on a physical characteristic of a wireless network environment to generate a second cryptographic key.

Example 2 includes the non-transitory computer readable medium of example 1, wherein the instructions, when executed, cause the machine to at least one of encrypt data using the second cryptographic key or decrypt data using the second cryptographic key.

Example 3 includes the non-transitory computer readable medium of example 1, wherein the parameter includes at least one of a signal return parameter or a clock synchronization time parameter.

Example 4 includes the non-transitory computer readable medium of example 3, wherein the signal return parameter is calculated based on a signal to noise parameter and a noise power parameter.

Example 5 includes the non-transitory computer readable medium of example 3, wherein the clock synchronization time parameter is based on a transmission time latency between the machine and an access point.

Example 6 includes the non-transitory computer readable medium of example 1, wherein the instructions, when executed, cause the machine to combine the first cryptographic key with the parameter by performing an exclusive OR operation using the first cryptographic key and the parameter.

Example 7 includes the non-transitory computer readable medium of example 1, wherein the instructions, when executed, cause the machine to cause the parameter and the second cryptographic key to be stored in a secure storage.

Example 8 includes the non-transitory computer readable medium of example 1, wherein the instructions, when executed, cause the machine to generate the first cryptographic key.

Example 9 includes the non-transitory computer medium of example 1, wherein the parameter is a wireless network channel parameter.

Example 10 includes the non-transitory computer readable medium of example 1, wherein the instructions, when executed, cause the machine to combine the first cryptographic key with a plurality of parameters that are based on physical characteristics of the wireless network environment.

Example 11 includes the non-transitory computer readable medium of example 10, wherein the plurality of parameters include a wireless network signal return parameter and a wireless network clock synchronization time parameter.

Example 12 includes the non-transitory computer readable medium of example 1, wherein the instructions, when executed, cause the machine to retrieve the parameter from a wireless network interface.

Example 13 includes a computing device comprising at least one of memory or storage to store data and an encryption device, a wireless network interface to connect to a wireless network, at one processing device to combine the first cryptographic key with a parameter based on a physical characteristic of the wireless network associated with the wireless network interface to generate a second cryptographic key.

Example 14 includes the computing device of example 13, wherein the computing device is one of an enclave, a personal computer, a laptop computer, or a mobile phone.

Example 15 includes the computing device of example 13, wherein the physical characteristic is a wireless network channel parameter.

Example 16 includes the computing device of example 13, wherein the at least one processing device is to combine the first cryptographic key with the parameter based on an exclusive OR operation.

Example 17 includes the computing device of example 13, wherein the parameter associated with a first location is different than the parameter associated with a second location.

Example 18 includes a method to generate a second cryptographic key, the method comprising determining a first cryptographic key, and combining, via a logic circuitry, the first cryptographic key with a parameter based on a physical characteristic of a wireless network environment to generate the second cryptographic key.

Example 19 includes the method of example 18, further comprising at least one of encrypting data using the second cryptographic key or decrypting data using the second cryptographic key.

Example 20 includes the method of example 18, wherein the parameter includes at least one of a signal return parameter and a clock synchronization time parameter.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer readable medium comprising instructions that, when executed, cause a machine to at least:
determine a first cryptographic key; and
combine the first cryptographic key with a parameter based on a physical characteristic of a wireless network environment to generate a second cryptographic key.

2. The non-transitory computer readable medium of claim 1, wherein the instructions, when executed, cause the machine to at least one of encrypt data using the second cryptographic key or decrypt data using the second cryptographic key.

3. The non-transitory computer readable medium of claim 1, wherein the parameter includes at least one of a signal return parameter or a clock synchronization time parameter.

4. The non-transitory computer readable medium of claim 3, wherein the signal return parameter is calculated based on a signal to noise parameter and a noise power parameter.

5. The non-transitory computer readable medium of claim 3, wherein the clock synchronization time parameter is based on a transmission time latency between the machine and an access point.

6. The non-transitory computer readable medium of claim 1, wherein the instructions, when executed, cause the machine to combine the first cryptographic key with the parameter by performing an exclusive OR operation using the first cryptographic key and the parameter.

7. The non-transitory computer readable medium of claim 1, wherein the instructions, when executed, cause the machine to cause the parameter and the second cryptographic key to be stored in a secure storage.

8. The non-transitory computer readable medium of claim 1, wherein the instructions, when executed, cause the machine to generate the first cryptographic key.

9. The non-transitory computer readable medium of claim 1, wherein the parameter is a wireless network channel parameter.

10. The non-transitory computer readable medium of claim 1, wherein the instructions, when executed, cause the machine to combine the first cryptographic key with a plurality of parameters that are based on physical characteristics of the wireless network environment.

11. The non-transitory computer readable medium of claim 10, wherein the plurality of parameters includes a wireless network signal return parameter and a wireless network clock synchronization time parameter.

12. The non-transitory computer readable medium of claim 1, wherein the instructions, when executed, cause the machine to retrieve the parameter from a wireless network interface.

13. A computing device comprising:
at least one of memory or storage to store data and an encryption device;
a wireless network interface to connect to a wireless network; and
at least one processing device to combine a first cryptographic key with a parameter based on a physical characteristic of the wireless network associated with the wireless network interface to generate a second cryptographic key.

14. The computing device of claim 13, wherein the computing device is one of an enclave, a personal computer, a laptop computer, or a mobile phone.

15. The computing device of claim 13, wherein the physical characteristic is a wireless network channel parameter.

16. The computing device of claim 13, wherein the at least one processing device is to combine the first cryptographic key with the parameter based on an exclusive OR operation.

17. The computing device of claim 13, wherein the parameter associated with a first location is different than the parameter associated with a second location.

18. A method to generate a cryptographic key, the method comprising:
determining a first cryptographic key; and
combining, via a logic circuitry, the first cryptographic key with a parameter based on a physical characteristic of a wireless network environment to generate a second cryptographic key.

19. The method of claim 18, further comprising at least one of encrypting data using the second cryptographic key or decrypting data using the second cryptographic key.

20. The method of claim 18, wherein the parameter includes at least one of a signal return parameter and a clock synchronization time parameter.
